(19) United States
(12) Patent Application Publication
(10) Pub. No.: US 2026/0346732 A1
(43) Pub. Date: Nov. 5, 2026

(54) METHOD FOR OPERATING AN ELECTRIC DRIVE SYSTEM, COMPUTER PROGRAM PRODUCT, DATA STORAGE MEDIUM, ELECTRIC DRIVE SYSTEM, AND MOTOR VEHICLE

(71) Applicant: Robert Bosch GmbH, Stuttgart (DE)

(72) Inventor: Jochen Fassnacht, Calw (DE)

(21) Appl. No.: 19/102,879

(22) PCT Filed: Jun. 14, 2023
(86) PCT No.: PCT/EP2023/065886

§ 371 Date: Feb. 11, 2025

(30) Foreign Application Priority Data
Aug. 16, 2022 (DE) 10 2022 208 481.0

(51) Int. Cl. B60L 15/02

(52) U.S. Cl. CPC B60L 15/025; B60L 2210/40; B60L 2240/421; B60L 2240/423; B60L 2240/429; B60L 2240/527; B60L 2240/545; B60L 2240/547; B60L 2260/44

(57) ABSTRACT

A method for operating an electric drive system (1), in particular for an automotive vehicle, wherein the electric drive system (1) comprises power electronics (2), in particular an electric voltage transformer, an electric machine (3) controllable by the power electronics (2) and a battery (4) electrically connected or connectable to the power electronics (2), and wherein the power electronics (2) comprise at least one electrical phase (5) for controlling the electric machine (3). It is envisioned that that at least one voltage value of an electrical DC link voltage (U₁) of the power electronics (2) is estimated using a mathematical model of the drive system (1) depending on a predetermined speed and/or torque request for the electric machine (3), that at least one current value of an electrical current for one of the phases (5) and/or a rotor of the electrical machine (3) is provided as a function of the speed and/or torque request for the electrical machine (3) and predetermined by the estimated DC link voltage (U₁), and that the electric machine (3) is controlled depending on the predetermined current value.

The invention relates to a method of operating an electric drive system, in particular for a motor vehicle, wherein the electric drive system comprises power electronics, in particular an electric voltage transformer, an electric machine controllable by the power electronics and a battery electrically connected or connectable to the power electronics, and wherein the power electronics comprises at least one electric phase for controlling the electric machine.

Further, the invention relates to a computer program product that performs the above method when the computer program product is executed on a computer device. In addition, the invention relates to a data storage medium with such a computer program product as well as to an electric drive system with the computer device which is specifically adapted to execute the computer program product or the above-mentioned method, respectively. Finally, the invention relates to a motor vehicle having the electric drive system.

### PRIOR ART

Methods, electric drive systems, and motor vehicles of the type specified hereinabove are known from the prior art. Typically, in electric machines configured as externally-energized synchronous machines that are used for traction drives of battery-electric vehicles, a rotor flux and thus an induced pole spider voltage are set via an excitation current. This excitation current regulation is typically highly dynamic, in particular with a fast bang-bang controller or a fast PI regulator. Because the inductance of the rotor of the electric machine is usually very high, a change in the stator currents is only possible comparatively slowly despite the highly dynamic control.

Corresponding optimal current setpoint values in terms of efficiency for the stator currents in the d and q directions of the field-oriented control and for a rotor current are saved as tables, for example. These values are usually specified for field-oriented control and rotor current control, wherein these target values are set as dynamically and precisely as possible by the corresponding controls. For reasons of efficiency, for example, for traction drives in battery electric vehicles, an efficient and thus low rotor current is set at low torque requirements. If a high torque is then needed quickly, the rotor current required for this purpose can only be provided after a certain length of time, as described above. Therefore, in particular, a slew rate limiter is used for the current setpoint values for the stator currents, so that the necessary rotor current is first built up and then the appropriate stator currents, because the stator currents cannot set a sufficient torque without the rotor current.

In order to drive the electric machine as efficiently as possible using the power electronics assigned to it, the necessary stator currents must be set with the lowest DC link voltage possible. For example, the electric machine and the power electronics are configured to still provide the required torque at the lowest DC link voltage that occurs. Accordingly, the characteristic diagrams of the current setpoint values for the field-oriented control are calculated for just this lowest DC link voltage. As long as the electric machine and the power electronics are operated on or supplied with power by a stationary power grid, the DC link voltage is comparatively stable, so it is sufficient to only use characteristic diagrams for a constant DC link voltage. If, on the other hand, the electric machine and the power electronics are operated or powered by a mobile energy store, i.e. a battery or an accumulator, as provided in the method according to the invention, then significantly greater fluctuations in the DC link voltage are to be expected depending on the state of the energy storage.

For example, the control and characteristic diagram for the current setpoints are set to the lowest DC link voltage that occurs to ensure that sufficient control reserves are present and the control behavior results in an advantageous current regulation. Thus, the battery is loaded when a motor torque is set and the DC link voltage drops significantly. To this end, the lowest DC link voltage that occurs, i.e. the largest drop in the DC link voltage, is usually assumed to be a “worst-”” state of the battery, for example, at which the battery is at maximum discharge, has a minimum temperature and has reached an advanced or maximum aging state. Further, a maximum electrical removal rate of all auxiliary devices and the drive is typically assumed.

### DISCLOSURE OF THE INVENTION

The method according to the invention with the features of claim 1 is characterized in that at least one voltage value of an electrical DC link voltage of the power electronics is estimated using a mathematical model of the drive system depending on a predetermined speed and/or torque requirement for the electric machine, that at least one current value of an electric current for one of the phases and/or a rotor of the electric machine is predetermined as a function of the speed and/or torque requirement for the electric machine and specified using the estimated DC link voltage, and that the electric machine is controlled depending on the predetermined current value. Typically, when controlling the electric machine as described above, an excitation current is pre-determined, for example to set a particular torque for the electric machine, in particular at a predetermined speed of the electric machine. This excitation current is selected as a function of a minimum available DC link voltage from a characteristic diagram (voltage drops under load), wherein a “worst-case” scenario (state of the battery and drive system) is usually assumed. By estimating the DC link voltage accordingly and taking into account the estimated DC link voltage for the specification of the current value, it is advantageously ensured that the electric machine is operated or controlled comparatively by the power electronics with a further improved electrical efficiency. Particularly preferably, current values for the excitation current and stator currents are respectively pre-determined. The method according to the invention increases the efficiency of control, because the actual or estimated DC link voltage is usually higher than the minimum DC link voltage that occurs when the torque is reached, for example, because the battery is fully charged or only partially discharged, new or warm, and thus the DC link voltage drops significantly less than assumed when loaded. The method according to the invention is used to estimate the actually expected (higher) DC link voltage, and a suitable characteristic diagram with higher DC link voltage is in particular selected for the control and thus the control is optimized. The core of the method is optimization of the corresponding control and regulation concept. In particular, the voltage value of the DC link voltage is estimated at a known speed and for a predetermined torque setpoint using the mathematical model of the drive system. More particularly, the mathematical model takes into account at least one parameter of the battery, a power value of an electrical power consumption of the electric drive system, and/or an efficiency of the electric machine and power electronics, in particular as a function of the speed and/or torque requirement. The speed is in particular dependent on a travel speed of the motor vehicle, if the electric drive system is used in a motor vehicle. The torque setpoint is in particular determined by a corresponding regulation level, for example a control device, and/or depending on a corresponding request by a user of the electric drive system, in particular a request for acceleration made by the driver of the motor vehicle. The current values, in particular the stator currents and the rotor current as described above, are set for the torque setpoint at a current speed using a DC link voltage of the power electronics that are to be set when stationary in this”. Current values are not initially set as a function of an assumed too low DC link voltage and then corrected, for example when the torque setpoint is reached, but rather the current values are already adjusted correctly when the system is stationary using the method according to the invention for the expected, i.e., the estimated DC link voltage. Corresponding iteration steps for correcting the current values as described above are advantageously eliminated with the method according to the invention. The mathematical model of the drive system is required for this immediate correct setting of the current values. The advantage of the method is that the DC link voltage to be expected at the torque setpoint and the speed is estimated at least approximately in advance via the model and optimal characteristic diagrams or regulator parameters are selected virtually without any delay. This improves the dynamics and efficiency of the drive system as described above. No additional hardware is required, only a corresponding regulation and a corresponding mathematical model for the DC link voltage.

According to a preferred further development of the invention, it is provided that the mathematical model takes into account a resistance value of an internal resistance of the battery and/or a voltage value of an electrical no-load voltage of the battery. By taking into account the resistance value and/or the voltage value, it is advantageously ensured that a load and/or wear condition of the battery is depicted in the mathematical model.

Particularly preferably, it is contemplated that the resistance value and/or the voltage value be determined depending on a battery temperature and/or age. This method of determining the resistance value and/or the voltage value is a particularly simple method of determination. Particularly preferably, the resistance value and/or the voltage value of a battery management system executed on the control device associated with the battery are adjusted based on the temperature and the age of the battery. Because the temperature changes relatively slowly and aging is very slow, the temperature and aging values are alternatively transmitted to a further control device, in particular a computer device, carrying out the method according to the invention, for example via an already existing vehicle bus, in order to adjust the resistance value and/or the voltage values there.

According to a preferred further development of the invention, it is provided that the mathematical model takes into account a power value of an electrical consumption power of an electrical device connected to the battery. Through such consideration of the electrical power consumption, it is advantageously ensured that the mathematical model is further approximated to an actual load situation of the electrical drive system.

More preferably, it is contemplated that the mathematical model account for a power value of an electric power of the drive system. Considering the electric power in this way results in the advantage that the mathematical model is further approximated to an actual load situation of the electric drive system.

According to a preferred further development of the invention, it is provided that the current value for the predetermined speed or torque request is retrieved from a characteristic diagram associated with the estimated voltage value of the DC link voltage, in particular a look-up table. Using such a characteristic diagram creates a particularly simple and secure way to retrieve the current value.

It is particularly preferred that the mathematical model is structured as a monitor, wherein the estimated voltage value for the DC link voltage is compared to a measured voltage value. This provides the advantage that accuracy of the estimation of the DC link voltage is further improved. After the voltage values are compared, the states in particular are adjusted. If an extended Kalman filter is used, its parameters are also particularly preferably adjusted. Further, preferably, the adjustment or correction of the states or parameters is suspended when the model for estimating the DC link voltage for a desired future torque to be applied is employed.

The computer program according to the invention for execution on a computer device having the features of claim 8 is characterized in that it performs the method according to the invention when it is used as intended. This results in the aforementioned advantages.

The data carrier according to the invention having the features of claim 9 is characterized by the computer program product according to the invention stored thereon.

The electric drive system, in particular for a motor vehicle, having the features of claim 10 comprises power electronics, in particular an electric voltage transformer, an electric machine controllable by the power electronics, and a battery electrically connected or connectable to the power electronics, wherein the power electronics comprises at least one electrical phase for controlling the electric machine. The electric drive system is characterized by a computer device specifically adapted to perform the method according to the invention or to execute the computer program product according to the invention. This also results in the aforementioned advantages. Preferably, the computer device is a control device associated with the electric drive system, in particular in the motor vehicle. The electric machine, in particular, an externally excited synchronous machine, as described above. Alternatively, the electric machine is another externally-excited machine driven by power electronics, a permanently-energized or electrically-energized synchronous machine, or an asynchronous machine. The electric drive system is particularly provided for use in an industrial machine or household appliance, in particular in white goods.

The motor vehicle having the features of claim 11 is characterized by the electric drive system according to the invention. This also results in the aforementioned advantages.

Further preferred features and combinations of features result from the previous descriptions and from the claims. The invention will be explained in further detail hereinafter with reference to the drawings. Shown are:

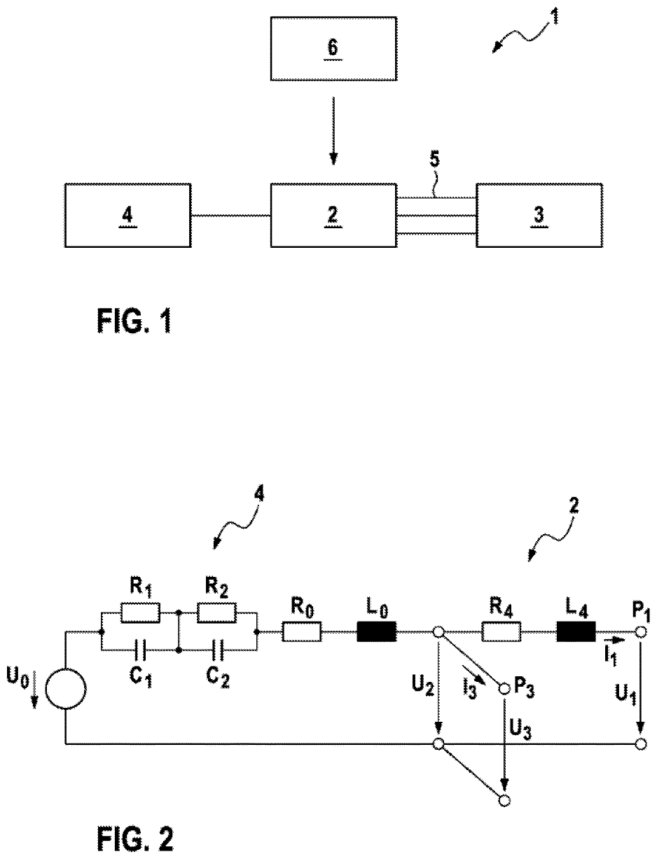

FIG. 1 a schematic representation of an electric drive system,

FIG. 2 a first electrical equivalent circuit diagram for a mathematical model of the drive system,

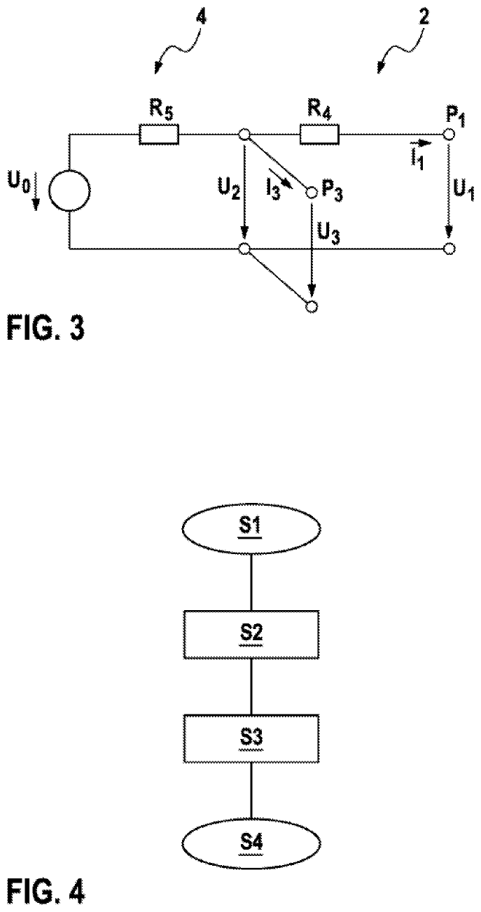

FIG. 3 a second electrical equivalent circuit diagram for the model, and

FIG. 4 a method for operating the drive system.

FIG. 1 shows a schematic representation of an electric drive system 1. The electric drive system 1 comprises power electronics 2, in the present “an electric voltage transformer, in particular an inverter, an electric machine 3 that can be controlled by the power electronics 2, and a battery 4 electrically connected to the power electronics 2.

The power electronics 2 are configured to control at least one electrical phase 5, in the present “all three electrical phases 5 of the electric machine 3. In the present case, the power electronics 2 are associated with a computer device 6, in particular a control device.

FIG. 2 shows a first electrical equivalent circuit diagram for a mathematical model of the electric drive system 1. With the help of this model, it is possible to estimate a DC link voltage Ui of the power electronics 2. The equivalent circuit diagram comprises electrical switching elements, which model parameters of the battery 4 as well as secondary electrical devices and the drive itself.

The electrical equivalent circuit diagram is derived from equivalent circuit diagrams known from the literature in the art. The parameters of the battery 4 are shown as two electrical resistors R₁, R₂, that are each connected in parallel to capacitances C₁, C₂ and thus form RC circuits. A further resistor R₀ and an inductance Lo are arranged in a series.

These components together represent relevant parameters of the battery 4. The battery 4 has a no-load voltage U₀ and an output voltage U₂. For example, an ancillary device characterized by an electrical power P₃, an electrical current I₃ and an electrical voltage U₃ is connected to the battery 4.

Finally, the power electronics 2 are also connected to the battery 4, wherein further losses, in particular conduction losses in a wiring system, for example an on-board power system, between the battery 4 and the power electronics 2 are represented by a further resistor R₄ and an inductance L₄.

The power electronics 2 then have the corresponding DC link voltage U₁, a DC link current I₁ and a DC link power P₁. If the values for the respective electrical components are known, these can be estimated using the model.

However, the stationary DC link voltage is primarily relevant for calculating the DC link voltage U₁ for control purposes. A simplified equivalent circuit diagram is sufficient for calculating these. This is illustrated as a second electrical equivalent circuit diagram for the model in FIG. 3.

Instead of the aforementioned parameters of the battery from FIG. 2, only a single resistor R₅ is shown, which depicts the internal resistance of the battery as a whole. To estimate the DC link voltage U₁, the no-load voltage U₀ and the internal resistance Rs are thus sufficient as a parameter of the battery 4. The losses between and in the wiring and power electronics 2 are only represented by the resistor R₄. The other electrical components are omitted.

Finally an advantageous method for operating the electric drive system 1 is described with reference to FIG. 4. For this purpose, FIG. 4 shows the method in the form of a flow chart. In particular, the method ensures that the electrical machine 3 is operated and controlled as efficiently as possible.

In a step S1, the method begins with receiving a predetermined speed and/or torque request for the electric machine 3. In particular, the computer device 6 is specifically designed to carry out the method described in the following or execute a computer program product that carries out the method.

In a step S2, at least one voltage value of an electrical DC link voltage U₁ of the power electronics 2 is estimated using a mathematical model, preferably starting from the equivalent circuit diagram for the mathematical model shown in FIG. 3, as a function of the speed and/or torque requirement.

To this end, the mathematical model, as described above, takes into account in particular at least one resistance value R₅ of an internal resistor of the battery 4 and a voltage value of an electrical no-load voltage U₀ of the battery 4. These are determined in particular as a function of a battery temperature and/or an age of the battery 4.

Further, the mathematical model takes into account in particular at least one power value of an electrical consumption power P₃ of an electrical device connected to the battery 4, a power value of an electrical drive power of the drive system 1, and/or losses in or between the wiring and power electronics 2, in particular characterized by a resistance value of a corresponding resistor R₄, as described above.

In a step S3, at least one current value of an electrical current for one of the phases 5 and/or a rotor of electric machine 3 is provided as a function of the speed and/or torque request for the electric machine 3 and the DC link voltage U₁ estimated in step S2. The current value is in particular retrieved from a characteristic diagram associated with the estimated voltage value of the DC link voltage U₁.

In a step S4, the electric machine 3 is finally activated depending on the predetermined current value. The method hereby ends.

1. A method for operating an electric drive system (1) for an automotive vehicle, wherein the electric drive system (1) comprises power electronics (2) that include an electric voltage transformer, an electric machine (3) configured to be controlled by the power electronics (2) and a battery (4) configured to be electrically connected to the power electronics (2), and wherein the power electronics (2) comprise at least one electrical phase (5) for controlling the electric machine (3), the method comprising
estimating at least one voltage value of an electrical DC link voltage (U₁) of the power electronics (2) using a mathematical model of the drive system (1) depending on a predetermined speed and/or torque request for the electric machine (3),
providing at least one current value of an electrical current for one of the phases (5) and/or a rotor of the electrical machine (3) as a function of the speed and/or torque request for the electrical machine (3) and the estimated DC link voltage (U₁), and
controlling the electric machine (3) based on the predetermined current value.

2. The method according to claim 1, wherein the mathematical model takes into account a resistance value of an internal resistor (R₅) of the battery (4) and/or a voltage value of a no-load circuit voltage (U₀) of the battery (4).

3. The method according to claim 2, wherein the resistance value and/or the voltage value are determined as a function of a battery temperature and/or an age of the battery (4).

4. The method according to claim 1, wherein the mathematical model takes into account a power value of an electrical consumption power (P₃) of an electrical device connected to the battery (4).

5. The method according to claim 1, wherein the mathematical model takes into account a power value of an electric drive power of the drive system (1).

6. The method according to claim 1, wherein the current value for the predetermined speed or torque request is retrieved from a characteristic diagram associated with the estimated voltage value of the DC link voltage (U₁).

7. The method according to claim 1, wherein the mathematical model is designed as a monitor, wherein the estimated voltage value for the DC link voltage (U₁) is compared to a measured voltage value.

8. A non-transitory, computer-readable storage medium containing instructions that when executed by a computer cause the computer to operate an electric drive system (1) for an automotive vehicle, wherein the electric drive system (1) comprises power electronics (2) that include an electric voltage transformer, an electric machine (3) configured to be controlled by the power electronics (2) and a battery (4) configured to be electrically connected to the power electronics (2), and wherein the power electronics (2) comprise at least one electrical phase (5) for controlling the electric machine (3), by
estimating at least one voltage value of an electrical DC link voltage (U₁) of the power electronics (2) using a mathematical model of the drive system (1) depending on a predetermined speed and/or torque request for the electric machine (3),
providing at least one current value of an electrical current for one of the phases (5) and/or a rotor of the electrical machine (3) as a function of the speed and/or torque request for the electrical machine (3) and the estimated DC link voltage (U₁), and
controlling the electric machine (3) based on the predetermined current value.

9. (canceled)

10. An electric drive system (1) for a motor vehicle, the electric drive system (1) comprising:
a power electronics (2) that includes an electric voltage transformer,
an electric machine (3) configured to be controlled by the power electronics (2),
a battery (4) configured to be electrically connected to the power electronics (2), wherein the power electronics (2) comprise at least one electrical phase (5) for controlling the electrical machine (3), and
a computer (6) configured to
estimate at least one voltage value of an electrical DC link voltage (U₁) of the power electronics (2) using a mathematical model of the drive system (1) depending on a predetermined speed and/or torque request for the electric machine (3),
provide at least one current value of an electrical current for one of the phases (5) and/or a rotor of the electrical machine (3) as a function of the speed and/or torque request for the electrical machine (3) and the estimated DC link voltage (U₁), and
control the electric machine (3) based on the predetermined current value.

11. A motor vehicle wherein an electric drive system (1) according to claim 10.
